(19) United States
(12) Patent Application Publication
(10) Pub. No.: US 2013/0316203 A1
(43) Pub. Date: Nov. 28, 2013

(54) BATTERY MODULE

(71) Applicant: DELTA ELECTRONICS, INC., Taoyuan Hsien (TW)

(72) Inventors: Yuan-Kun HSIAO, TAOYUAN HSIEN (TW); Jian-Jang LAI, TAOYUAN HSIEN (TW); Mu-Min LIN, TAOYUAN HSIEN (TW)

(73) Assignee: DELTA ELECTRONICS, INC., TAOYUAN HSIEN (TW)

(21) Appl. No.: 13/831,868

(22) Filed: Mar. 15, 2013

(30) Foreign Application Priority Data
May 22, 2012 (TW) 101118094

(51) Int. Cl. H01M 10/50

(52) U.S. Cl. CPC H01M 10/5004
USPC 429/83; 429/99; 429/72

(57) ABSTRACT

A battery module includes a frame, at least one first batteries array, at least one second batteries array, at least one heat dissipation slot and at least one modular heat dissipation structure. The first batteries array is accommodated in the frame, and includes a plurality of first batteries substantially arranged along a first direction. The second batteries array is accommodated in the frame, and includes a plurality of second batteries substantially arranged along the first direction. The modular heat dissipation structure is inserted into the heat dissipation slot and thermally contacts the first batteries and the second batteries, wherein the modular heat dissipation structure can be chosen as various types according to heat dissipation demands.

### RELATED APPLICATIONS

This application claims priority to Taiwan Application Serial Number 101118094, filed May 22, 2012, which is herein incorporated by reference.

### BACKGROUND

1. Technical Field

Embodiments of the present disclosure relate to a battery module. More particularly, embodiments of the present disclosure relate to a battery module with a heat dissipation structure.

2. Description of Related Art

In recent years, energy issues have been attracting much global attention due to gradual shortage of oil reserve. To address the issues of energy shortage, exploring alternative energy technologies is inevitably becoming one of major policy for countries around the world. For example, with the awareness of environmental protection, manufacturers of vehicles are eager to use a cell as power source in place of the conventional fossil fuels.

In an electrically driven vehicle, the batteries in the battery module are cyclically charged and discharged in high C-rate, which may instantaneously cause high temperature. However, concerning dimension limitation, waterproof and dustproof requirements, the battery module cannot accommodate heat dissipation fans or other heat dissipation devices to forcedly introduce external air into battery module. Therefore, heat generated from the batteries can only be dissipated by free convection.

However, free convection cannot effectively remove the heat from the batteries, which causes significant raise in temperature. In the electrically driven vehicle, lithium batteries are generally applied for providing power, and nevertheless, the high-temperature surrounding will reduce lifetime of the lithium battery or even directly disable it, In a worse case, the battery may even explode or burn itself.

In view of the foregoing, it is really important to promote the heat to dissipation ability of the battery module.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In accordance with one embodiment of the present disclosure, a battery module includes a frame, at least one first batteries array, at least one second batteries array, at least one heat dissipation slot, and at least one modular heat dissipation structure. The first batteries array is accommodated in the frame, and includes a plurality of first batteries substantially arranged along a first direction. The second batteries array is accommodated in the frame, and includes a plurality of second batteries substantially arranged along the first direction. The heat dissipation slot is formed between the first batteries array and the second batteries array. The modular heat dissipation structure is inserted into the heat dissipation slot according to heat dissipation demands and thermally contacting the first batteries and the second batteries. The modular heat dissipation structure is a heat storage structure, a finned structure, a flow channel structure, or an external heat transfer structure.

It is to be understood that both the foregoing general description and the following detailed description are by examples, and are intended to provide further explanation of the disclosure as claimed.

### BRIEF DESCRIPTION OF THE DRAWINGS

Embodiments of the disclosure can be more fully understood by reading the following detailed description of the embodiment, with reference made to the accompanying drawings as follows:

FIG. 1 is an exterior perspective view of a battery module in accordance with one embodiment of the present disclosure;

FIG. 2 is an interior perspective view of the battery module of FIG. 1;

FIG. 3 is an exterior perspective view of the battery module in accordance with another embodiment of the present disclosure;

FIG. 4 is a schematic diagram of one heat dissipation mechanism of the battery module shown in FIG. 2;

FIG. 5 is a schematic diagram of another heat dissipation mechanism of the battery module shown in FIG. 2;

FIG. 6A is a perspective view of the modular heat dissipation structure 200 in accordance with one embodiment of the present disclosure;

FIG. 6B is a perspective view of the modular heat dissipation structure in accordance with another embodiment of the present disclosure;

FIG. 6C is a perspective view of the modular heat dissipation structure 200 in accordance with another embodiment of the present disclosure;

FIG. 7 is a partial front view of the modular heat dissipation structure and the first battery or the second battery of FIG. 2;

FIG. 8A is a diagram illustrating the temperature rise profile of the embodiment of FIG. 7;

FIG. 8B is another diagram illustrating the temperature rise profile of the embodiment of FIG. 7;

FIG. 9 is an interior perspective view of the battery module in accordance with another embodiment of the present disclosure;

FIG. 10 is an interior perspective view of the battery module in accordance with another embodiment of the present disclosure;

FIG. 11 is an interior perspective view of the battery module in accordance with another embodiment of the present disclosure;

FIG. 12 is a front view of the battery module of FIG. 11;

FIG. 13 is a cross-sectional view of the battery module in accordance with another embodiment of the present disclosure;

FIG. 14 is a cross-sectional view of the battery module in accordance with another embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

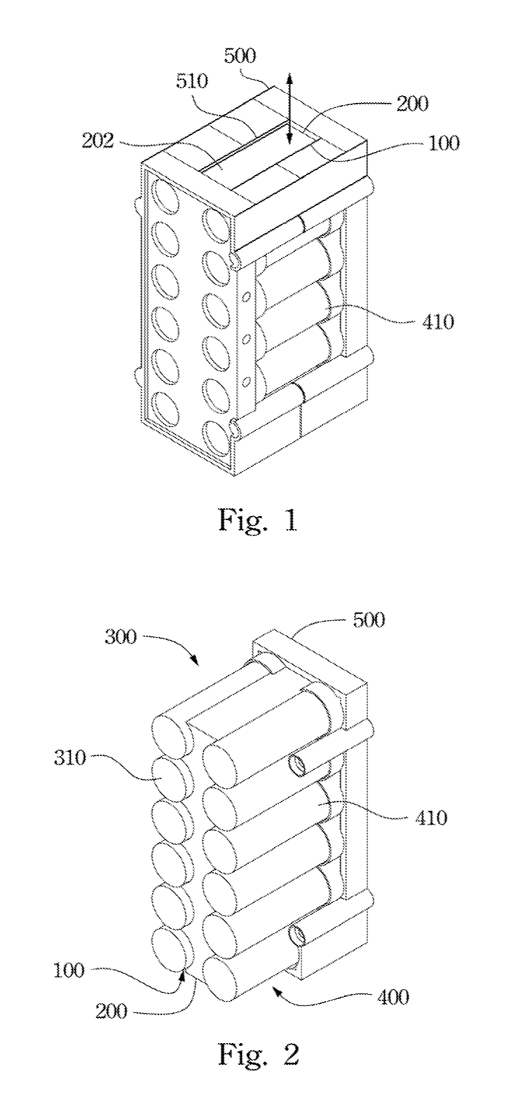

FIG. 1 is an exterior perspective view of a battery module in accordance with one embodiment of the present disclosure. FIG. 2 is an interior perspective view of the battery module of FIG. 1. As shown in FIGS. 1 and 2, the battery module of the embodiment may include a frame 500, at least one first batteries array 300, at least one second batteries array 400, at least one heat dissipation slot 100, and at least one modular heat dissipation structure 200. The first batteries array 300 is accommodated in the frame 500, and includes a plurality of first batteries 310 substantially arranged along a first direction. The second batteries array 400 is accommodated in the frame 500, and includes a plurality of second batteries 410 substantially arranged along the first direction. In other words, the second batteries array 400 including the second batteries 410 is substantially parallel to the first batteries array 300 including the first batteries 310. The heat dissipation slot 100 is formed between the first batteries array 300 and the second batteries array 400. The modular heat dissipation structure 200 is inserted into the heat dissipation slot 100 according to heat dissipation demands and thermally contacting the first batteries 310 and the second batteries 410. The modular heat dissipation structure 200 can be a heat storage structure, a finned structure, a flow channel structure, or an external heat transfer structure.

By aforementioned configuration, the modular heat dissipation structure 200 can be inserted into the heat dissipation slot 100, and directly store or conduct the thermal energy of the first batteries 310 and the second batteries 410. Further, aforementioned configuration can provide a convenient way for a manufacturer or a user to quickly install required modular heat dissipation structure 200 according to heat dissipation demands without modifying the battery module.

It should be noted that the “first direction” described in this disclosure refers to the arrangement direction of the first batteries 310 or the second batteries 410. Further, it should be noted that the term “substantially” described in this disclosure refers that any tiny variation or modification not affecting the essence of the technical feature can be included in the scope of the present disclosure. For example, the first batteries array 300 being “substantially” parallel to the second batteries array 400 not only includes the embodiment that the first batteries array 300 is exactly parallel to the second batteries array 400, but also includes the embodiment that the first batteries 300 and the second batteries array 400 are slightly non-parallel only if the heat dissipation slot 100 can be formed between the first batteries array 300 and the second batteries array 400. Further, it should be noted that the term “thermally contacting” or “thermal contact” described in this disclosure refers that thermal energy can be exchanged between two elements, components or devices, and physical contact is not necessarily required between these elements, components, or devices. In other words, only if thermal energy is exchanged between these elements, components, or devices, the definition of “thermally contacting” or “thermal contact” can be satisfied even though these elements, components, or devices are not physically contact with each other. Further, it should be noted that the term “storing thermal energy” or “heat storage” refers that the thermal energy can be stored in the modular heat dissipation structure 200, and it should also be noted that the term “conducting thermal energy” refers that heat exchange occurs between the modular heat dissipation structure 200 and the ambience.

in some embodiments, the battery module includes an opening 510 formed on the frame 500 and connected to the heat dissipation slot 100. As shown in FIG. 1, the opening 510 is formed on a surface of the frame 500, and the surface is substantially perpendicular to the first direction. Therefore, the modular heat dissipation structure 200 can be inserted into the heat dissipation slot 100 along the first direction through the opening 510, thereby installing the modular heat dissipation structure 200 quickly. It should be noted that the modular heat dissipation structure 200 should be inserted into the heat dissipation slot 100 before the first batteries array 300 and the second batteries array 400 are put in the frame 500.

Specifically, the shape and size of the opening 510 can be substantially the same as the surface 202 of the modular heat dissipation structure 200 that is perpendicular to the first direction. The modular heat dissipation structure 200 can be exactly fitted in the heat dissipation slot 100, so as to reduce the thermal resistance to the first batteries 310 and the second batteries 410.

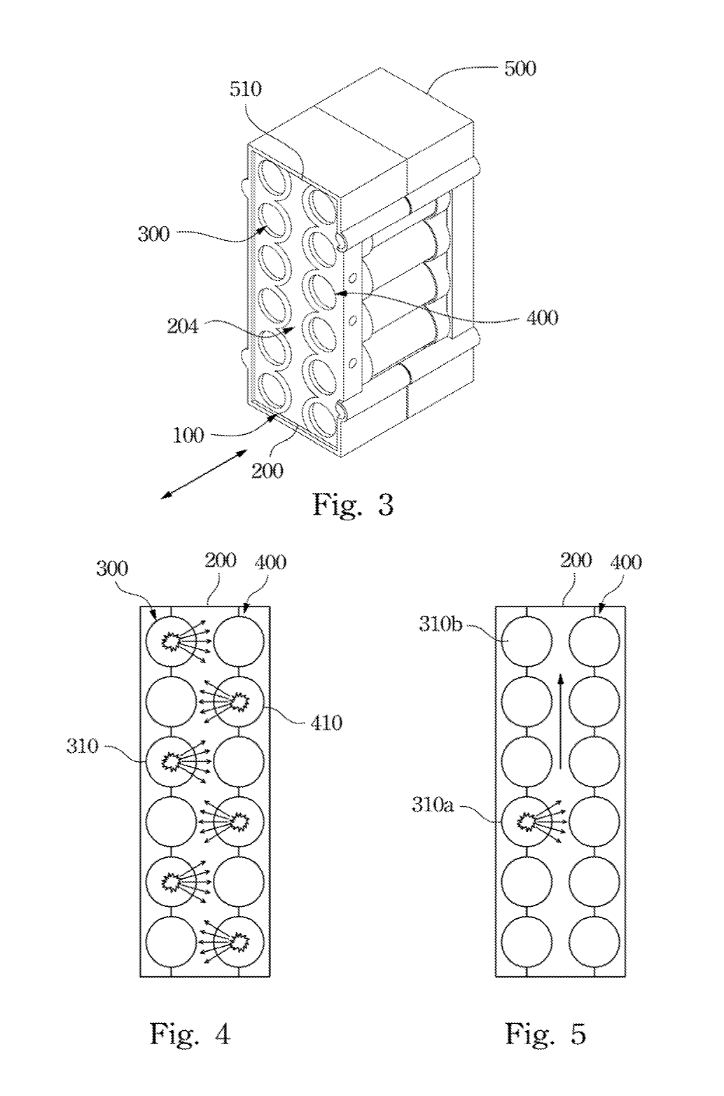

FIG. 3 is an exterior perspective view of the battery module in accordance with another embodiment of the present disclosure. This embodiment is similar to which is shown in FIG. 1, and the main difference is that the opening 510 is formed on the surface of the frame 500 that is substantially parallel to the first direction. Therefore, the modular heat dissipation structure 200 can be inserted into the heat dissipation slot 100 along the direction that is perpendicular to the first direction through the opening 510, whereby installing the modular heat dissipation structure 200 quickly.

Specifically, the shape and size of the opening 510 can be substantially the same as the surface 204 of the modular heat dissipation structure 200 that is parallel to the first direction. The modular heat dissipation structure 200 can be exactly fitted in the heat dissipation slot 100, so as to reduce the thermal resistance to the first batteries 310 and the second batteries 410.

FIG. 4 is a schematic diagram of one heat dissipation mechanism of the battery module shown in FIG. 2. In this embodiment, the modular heat dissipation structure 200 is a heat storage structure. The heat storage structure can be a solid metal that is made of material with high thermal conductivity such as aluminum or copper. Under circumstance without any external heat dissipation source, the modular heat dissipation structure 200 can be a transient thermal capacity for storing thermal energy generated from the first batteries 310 and the second batteries 410. Specifically, when the first batteries 310 and the second batteries 410 charge or discharge, the temperature thereof increases, the first batteries 310 and the second batteries 410 provide temperature gradient for the modular heat dissipation structure 200, so that part of thermal energy can be transmitted to the modular heat dissipation structure 200. The thermal energy can be transmitted along directions as shown as the radial arrows around the first batteries 310 and the second batteries 410. The modular heat dissipation structure 200 can store thermal energy by the inherent thermal capacity thereof, so as to slow down the temperature increasing speed of the first batteries 310 and the second batteries 410.

FIG. 5 is a schematic diagram of another heat dissipation mechanism of the battery module shown in FIG. 2. Similar to FIG. 4, the modular heat dissipation structure 200 is a heat storage structure. The heat storage structure can be a solid metal as a transient thermal capacity, absorbing part of thermal energy generated from the first batteries 310 and the second batteries 410. Further, if the temperature of the first battery 310a is higher than the temperature of the first battery 310b, a heat flow channel can be formed in the modular heat dissipation structure 200 to transmit thermal energy from the location of the modular heat dissipation structure 200 that is close to the first battery 310a to the location of the modular heat dissipation structure 200 that is close to the first battery 310b. Therefore, the modular heat dissipation structure 200 can inherently balance the temperature difference inside the battery module.

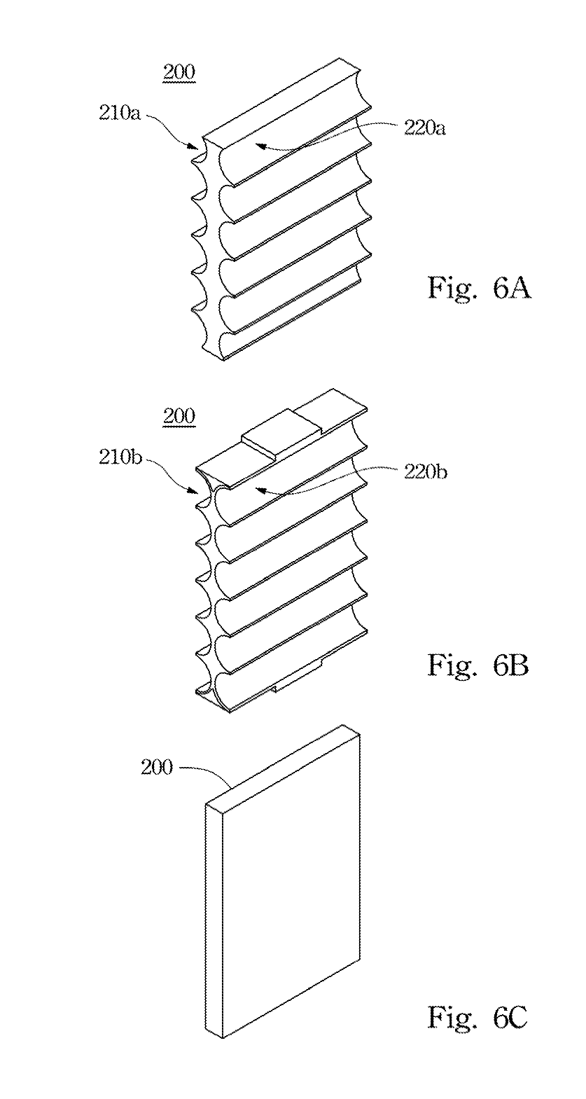

In some embodiments, the modular heat dissipation structure 200 covers at least partial surface of the first batteries 310 and the second batteries 410. For example, FIG. 6A can be referred, and this figure is a perspective view of the modular heat dissipation structure 200 in accordance with one embodiment of the present disclosure. As shown in FIG. 6A, the battery module may include a plurality of first heat dissipation grooves 210a and a plurality of second heat dissipation grooves 220a. The first heat dissipation grooves 210a and the second heat dissipation grooves 220a can be formed on opposite sides of the modular heat dissipation structure 200 that respectively face the first batteries 310 and the second batteries 410 (See FIG. 2). The size and shape of the first heat dissipation grooves 210a and the second heat dissipation grooves 220a can be similar to the first batteries 310 and the second batteries 410. Specifically, if the first batteries 310 and the second batteries 410 are Cylinder-shaped, the first heat dissipation grooves 210a and the second heat dissipation grooves 220a can be arc-shaped with similar radius.

Therefore, the first heat dissipation grooves 210a and the second heat dissipation grooves 220a can respectively cover at least partial surface of the first batteries 310 and the second batteries 410, so as to increase the thermal contact area between the modular heat dissipation structure 200 and the first batteries 310, and increase the thermal contact area between the modular heat dissipation structure 200 and the second batteries 410, thereby promoting heat dissipation ability.

FIG. 6B is a perspective view of the modular heat dissipation structure 200 in accordance with another embodiment of the present disclosure. This embodiment is similar to which of the FIG. 6A, and the main difference is that the first heat dissipation grooves 210b and the heat dissipation grooves 220b occupy more space in the modular heat dissipation structure 200, so that the modular heat dissipation structure of FIG. 68 is lighter than which of FIG. 6A and the thermal contact area between the modular heat dissipation structure 200 and the first batteries 310, the second batteries 410 is also promoted.

FIG. 6C is a perspective view of the modular heat dissipation structure 200 in accordance with another embodiment of the present disclosure. As shown in FIG. 6C, the modular heat dissipation structure 200 can be a cuboid. This structure of the cuboid is simple, easy to manufacture, and lighter. The manufacturer can choose modular heat dissipation structure 200 of FIG. 6A, 6B or 6C depending on balance between heat dissipation ability and weight.

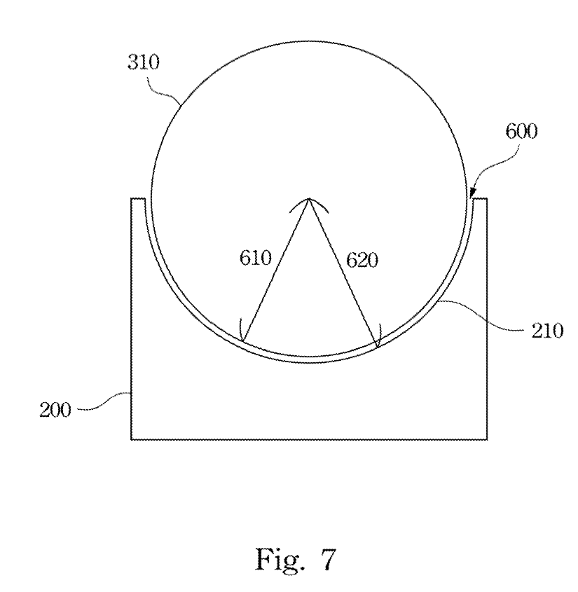

FIG. 7 is a partially front view of the modular heat dissipation structure 200 and the first battery 310 or the second battery 410 of FIG. 2. Because the first battery 310 and the second battery 410 are similar to each other, this figure only sketches the first battery 310 for simplicity. In this embodiment, the heat dissipation structure 200 defines tolerance 600 with each of the first batteries 310. Similarly, the modular heat dissipation structure 200 also defines tolerance 600 with each of the second batteries 410 (See FIG. 4 or 5). Specifically, the first battery 310 has a battery radius 610, and the modular heat dissipation structure 200 has a first heat dissipation groove 210 with a groove radius 620. The difference between the battery radius 610 and the groove radius 620 is defined as the tolerance 600.

By modifying the tolerance, a preferred thermal resistance between the first battery 310 and the modular heat dissipation structure 200 can be obtained. Preferably, the tolerance 600 can range from about 0.2 mm to about 0.8 mm. For example, the groove radius 620 can be 18.6 mm, and the battery radius 610 can be 18.4 mm, and the tolerance 600 therebetween can be 0.2 mm. Because the tolerance 600 is formed between the first battery 310 and the modular heat dissipation structure 200, air exists therebetween. Typical thermal conductivity of air is about 0.024 W/m-° C. By calculation, it can be obtained that the maximum thermal resistance is 10.48° C./W and the minimum thermal resistance is 2.6° C./W (when the tolerance 600 ranges from about 0.2 mm to about 0.8 mm.

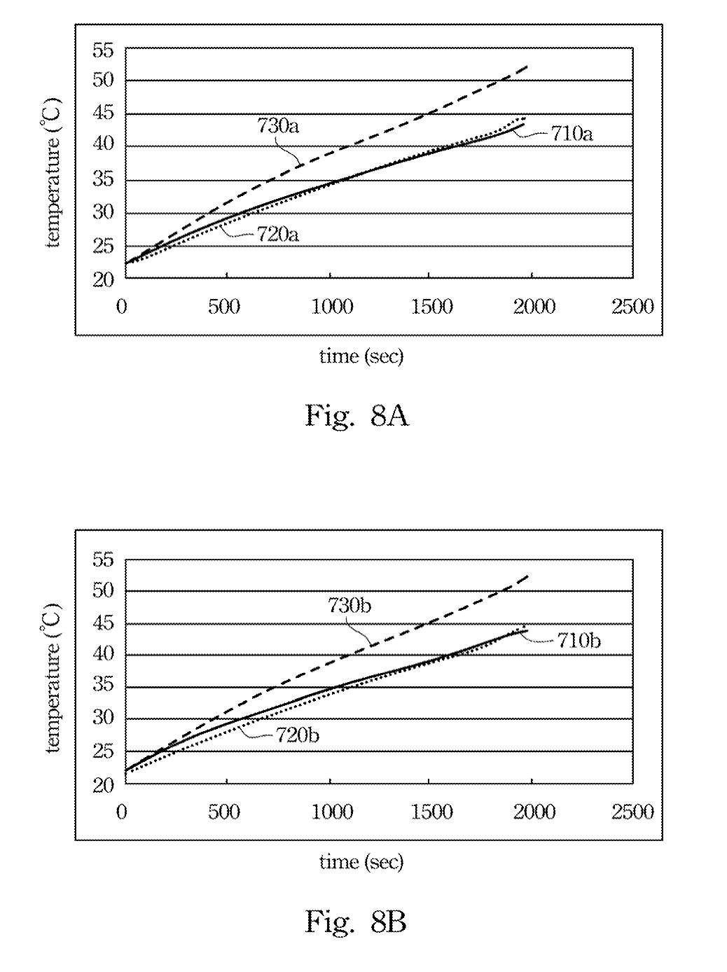

FIG. 8A is a diagram illustrating the temperature rise profile of the embodiment of FIG. 7. Specifically, the line 710a and the line 720a respectively refer to the calculation values and the experimental values when the thermal resistance of the modular heat dissipation structure 200 is 2.6° C./W. The line 730a refers to the experimental values of the battery module without modular heat dissipation structure 200. As shown in FIG. 8A, the battery module with modular heat dissipation structure 200 can significantly slow down the temperature increasing speed.

FIG. 8B is another diagram illustrating the temperature rise profile of the embodiment of FIG. 7. Specifically, the line 710b and the line 720b respectively refer to the calculation values and the experimental values when the thermal resistance of the modular heat dissipation structure 200 is 10.48° C./W. The line 730b refers to the experimental values of the battery module to without modular heat dissipation structure 200. As shown in FIG. 8A, the battery module with modular heat dissipation structure 200 can still slow down the temperature increasing speed even though the thermal resistance is high (10.48° C./W).

Based on FIGS. 8A and 8B, it can be understood that the temperature increasing speed can be slowed down under aforementioned range of the tolerance 600, regardless the thermal resistance is high or low. The modular heat dissipation structure 200 can certainly facilitate to dissipate heat of the battery module.

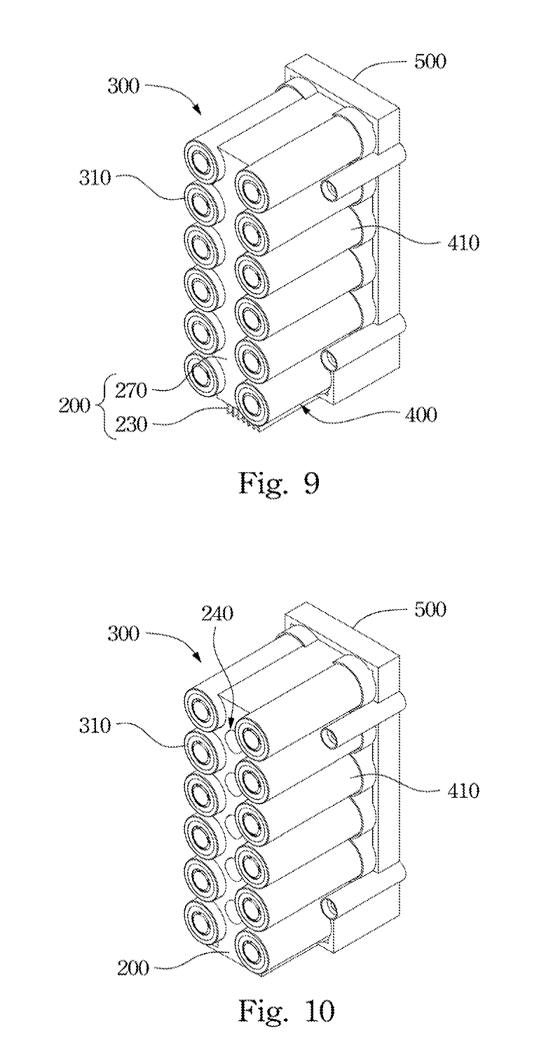

FIG. 9 is an interior perspective view of the battery module in accordance with another embodiment of the present disclosure. In this embodiment, the modular heat dissipation structure 200 is a finned structure. The finned structure includes a body 270 and a plurality of fins 230. The fins 230 are disposed on a surface of the body 270 substantially perpendicular to the first direction. Specifically, the fins 230 are disposed on the body 270 with intervals for enhancing heat convection ability. Therefore, the body 270 can conduct the thermal energy generated from the first batteries 310 and the second batteries 410 to the fins 230, and the fins 230 can transmit the thermal energy to the ambience via heat convection, thereby achieving heat dissipation.

FIG. 10 is an interior perspective view of the battery module in accordance with another embodiment of the present disclosure. This embodiment is similar to which of FIG. 2, and the main difference is that the battery module of this embodiment may includes a plurality of holes 240 formed in the modular heat dissipation structure 200. The holes 240 are arranged substantially along the first direction with intervals. This embodiment can be applied in a circumstance with external heat dissipation sources, such as wind.

Due to the existence of the external heat dissipation source, the modular heat dissipation structure 200 only has to transmit thermal energy to the ambience, and is not required to store thermal energy. In other words, the modular heat dissipation structure 200 is not required to be a solid body. Therefore, the modular heat dissipation structure 200 can include a plurality of holes 240, so that the weight of the modular heat dissipation structure 200 can be reduced and heat dissipation can still be implemented.

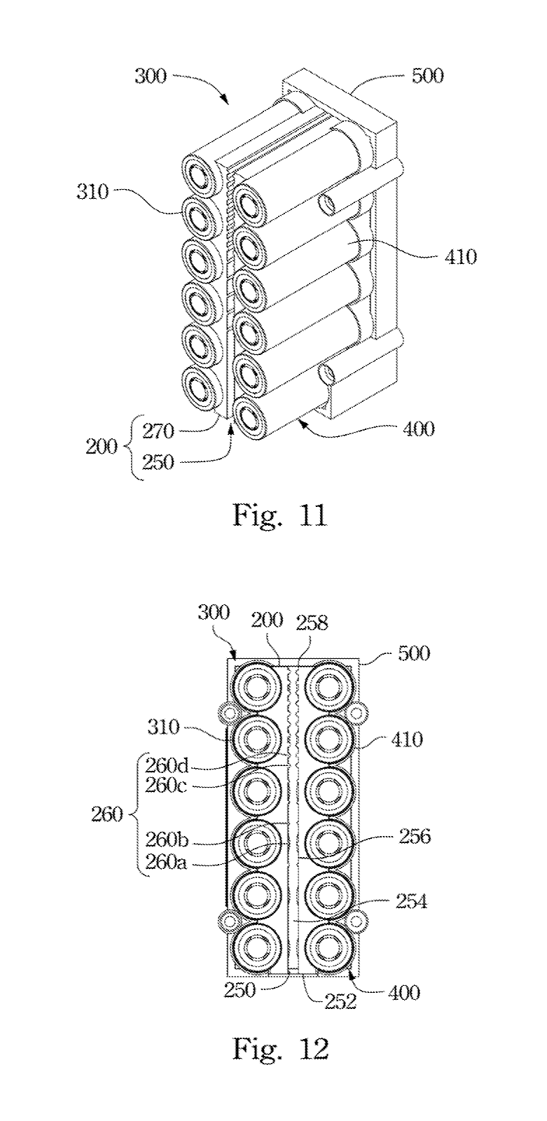

FIG. 11 is an interior perspective view of the battery module in accordance with another embodiment of the present disclosure. In this embodiment, the modular heat dissipation structure 200 can be a flow channel structure. The flow channel structure includes a body 270 and a flow channel 250. The flow channel 250 penetrates through the body 270 substantially along the first direction. Specifically, the modular heat dissipation structure 200 can be cut along the first direction as to form the flow channel 250. Fluid can pass through in the flow channel 250, thereby facilitating to transmit the thermal energy generated from the first batteries 310 and the second batteries 410 to the ambience.

FIG. 12 is a front view of the battery module of FIG. 11. As shown in FIG. 12, the flow channel 250 comprises an inlet 252, a front channel 254, a rear channel 256, and an outlet 258 connected one by one. In some embodiments, the battery module may include a plurality of turbulent structures 260. The turbulent structures 260 disposed in the flow channel 250. Specifically, the turbulent structures 260 are protruded on the inner all of the rear channel 256 of the flow channel 250. The turbulent structures 260 can be arranged with identical or different intervals for generating turbulent flow and promoting heat convection effect.

Because the fluid flows along the direction from the inlet 252 to the outlet 258, the temperature of the fluid passing though the rear channel 256 is higher than which passing through the front channel 254. The turbulent structures 260 disposed in the rear channel 256 can effectively promote heat convection ability on the rear channel 256, and therefore, the thermal energy transferred in the rear channel 256 can be higher than the thermal energy transferred in the front channel 254. Therefore, in comparison with the body 270 around the rear channel 256 without any turbulent structure 260, the temperature of the body 270 around the rear channel 256 with the turbulent structures 260 can be lowered.

Therefore, the first batteries 310 and the second batteries 410 around the front channel 254 can experience the heat dissipation ability similar to the first batteries 310 and the second batteries 410 around the rear channel 256.

In some embodiments, the distance between the adjacent turbulent structures 260 gradually decreases along a direction from the rear channel 256 to the outlet 258. Specifically, the interval between the turbulent structures 260a and 260b that are closer to the front channel 254 is greater than the interval between the turbulent structures 260c and 260d that are closer to the outlet 258. Therefore, the closer to the outlet 258 the turbulent structure 260 is, the better the heat convection ability is, so that the temperature of the fluid in the flow channel 250 can be balanced, and all of the first batteries 310 and the second batteries 410 can experience similar heat dissipation ability.

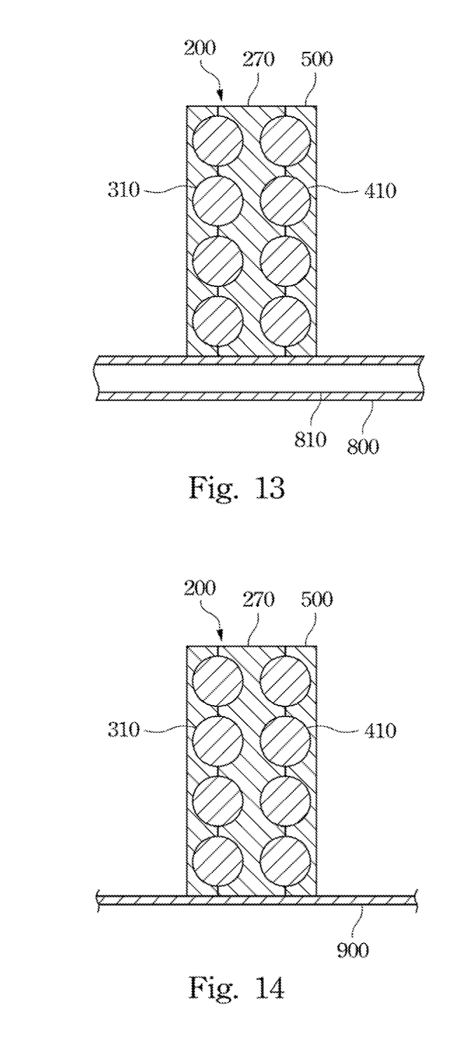

FIG. 13 is a cross-sectional view of the battery module in accordance with another embodiment of the present disclosure. As shown in FIG. 13, the modular heat dissipation structure 200 is an external heat transfer structure. The external heat transfer structure includes a body 270 and a heat dissipation plate 800. The heat dissipation plate 800 is placed on a surface of the body 270 substantially perpendicular to the first direction. For example, the heat dissipation plate 800 is a liquid cooling plate, and includes a cooling flow channel 810 for providing an external cooling flow to pass through. The cooling flow may include, but is not limited to include, water. The cooling flow channel 810 is substantially parallel to the surface of the body 270 that is substantially perpendicular to the first direction. Therefore, the modular heat dissipation structure 200 of this embodiment can conduct the thermal energy generated from the first batteries 310 and the second batteries 410 to the heat dissipation plate 800, and the heat dissipation plate 800 can remove the thermal energy by the external cooling flow.

FIG. 14 is a cross-sectional view of the battery module in accordance with another embodiment of the present disclosure. In this embodiment, the modular heat dissipation structure 200 is an external heat transfer structure. The external heat transfer structure includes a body 270 and a heater 290. The heater 290 is placed on a surface of the body 270 substantially perpendicular to the first direction. Therefore, if the battery module is placed in a cold circumstance and requires heat to work, the heater 900 can provide thermal energy to the body 270, and the body 270 can conduct the thermal energy to the first batteries 310 and the second batteries 410, so as to make the first batteries 310 and the second batteries 410 work normally. In some embodiments, the heater 900 can be provided power by an external power source to generate thermal energy.

In some embodiments, the surfaces that the modular heat dissipation structure 200 face the first batteries 310 and the second batteries 410 may alternatively adhered with a thermal pad or thermal glue.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A battery module, comprising:
frame;
at least one first batteries array accommodated in the frame, the first batteries array having a plurality of first batteries substantially arranged along a first direction:
at least one second batteries array accommodated in the frame, the second batteries array having a plurality of second batteries substantially arranged along the first direction;
at least one heat dissipation slot formed between the first batteries array and the second batteries array; and
at least one modular heat dissipation structure inserted into the heat dissipation slot according to heat dissipation demands and thermally contacting the first batteries and the second batteries, wherein the modular heat dissipation structure is a heat storage structure, a finned structure, a flow channel structure, or an external heat transfer structure.

2. The battery module of claim 1, further comprising an opening formed on the frame and connected to the heat dissipation slot.

3. The battery module of claim 2, wherein the opening is formed on a surface of the frame, and the surface is substantially perpendicular to the first direction.

4. The battery module of claim 2, wherein the opening is formed on a surface of the frame, and the surface is substantially parallel to the first direction.

5. The battery module of claim 1, wherein the heat storage structure is a solid metal.

6. The battery module of claim 1, wherein the modular heat dissipation structure covers at least partial surface of the first batteries and the second batteries.

7. The battery module of claim 6, further comprising:
a plurality of first heat dissipation grooves; and
a plurality of second heat dissipation grooves, the first heat dissipation grooves and the second heat dissipation grooves being formed on opposite sides of the modular heat dissipation structure, the opposite sides of the modular heat dissipation structure respectively facing the first batteries and the second batteries.

8. The battery module of claim 1, wherein the modular heat dissipation structure is a cuboid.

9. The battery module of claim 1, wherein the heat dissipation structure defines tolerance with each of the first batteries and each of the second batteries.

10. The battery module of claim 1, wherein the finned structure comprises:
a body; and
a plurality of fins disposed on a surface of the body, the surface being substantially perpendicular to the first direction.

11. The battery module of claim 1, further comprising:
a plurality of holes formed in the modular heat dissipation structure, the holes being arranged substantially along the first direction with intervals.

12. The battery module of claim 1, wherein the flow channel structure comprises:
a body; and
a flow channel penetrating through the body substantially along the first direction.

13. The battery module of claim 12, further comprising:
a plurality of turbulent structures disposed in the flow channel.

14. The battery module of claim 13, wherein the flow channel comprises an inlet, a front channel, a rear channel, and an outlet connected one by one, and the turbulent structures are disposed in the rear channel.

15. The battery module of claim 14, wherein distance between the adjacent turbulent structures gradually decreases along a direction from the rear channel to the outlet.

16. The battery module of claim 1, wherein the external heat transfer structure comprises:
a body; and
a heat dissipation plate placed on a surface of the body, the surface being substantially perpendicular to the first direction.

17. The battery module of claim 16, wherein the heat dissipation plate is a liquid cooling plate, and the liquid cooling plate comprises a cooling flow channel, and the cooling flow channel is substantially parallel to the surface of the body that is substantially perpendicular to the first direction.

18. The battery module of claim 1, wherein the external heat transfer structure comprises:
a body; and
a heater placed on a surface of the body, the surface being substantially perpendicular to the first direction.
